(19) United States
(12) Patent Application Publication
(10) Pub. No.: US 2010/0172537 A1
(43) Pub. Date: Jul. 8, 2010

(54) LOUDSPEAKER WITH REAR SURROUND SUPPORT

(76) Inventor: JACK BLAINE CAMPBELL, Gallatin, TN (US)

Correspondence Address: W. EDWARD RAMAGE, COMMERCE CENTER SUITE 1000, 211 COMMERCE ST, NASHVILLE, TN, 37201, US

(21) Appl. No.: 12/650,453

(22) Filed: Dec. 30, 2009

Related U.S. Application Data
(60) Provisional application No. 61/204,099, filed on Dec. 31, 2008.

(51) Int. Cl. H04R 1/00

(52) U.S. Cl. 381/423

(57) ABSTRACT

An improved dynamic loudspeaker that eliminates all visible mechanical components except the diaphragm when viewed from the front in a mounting baffle, and enables all of the front exposed diaphragm surface to emit sound. The surround support is entirely located within the perimeter edge of the diaphragm. A conventional dynamic loudspeaker motor/driver and voice coil system sized to fit behind and entirely inside the perimeter edge of the acoustic diaphragm permits the entire diaphragm to visually fill an opening in a mounting baffle and emit sound.

This application claims benefit of and priority to U.S. Provisional Application No. 61/204,099, entitled “LOUDSPEAKER WITH REAR UNDERHUNG SURROUND SUPPORT,” filed Dec. 31, 2008, by Jack Blaine Campbell, and is entitled to that filing date for priority. The specification, figures and complete disclosure of U.S. Provisional Application No. 61/204,099 are incorporated herein by specific reference for all purposes.

### FIELD OF INVENTION

This invention relates to an improved loudspeaker assembly.

### BACKGROUND OF INVENTION

Existing dynamic loudspeakers have some portion of the outermost mechanism existing outside the perimeter of the sound producing diaphragm. This is due to the use of flexible surround supports attached to the outermost perimeter edge of the diaphragm, thus requiring that some portion of either a housing or the surround support be viewable from the front when such a loudspeaker is mounted onto a baffle. Decorative grille coverings are often used to hide the exposed mechanical components of such an installed loudspeaker. Further, conventional dynamic loudspeaker construction using a perimeter-located surround support results in only a portion of the exposed front mechanical components to emit sound.

### SUMMARY OF INVENTION

In one exemplary embodiment, the invention comprises an improved dynamic loudspeaker that eliminates all visible mechanical components except the diaphragm when viewed from the front in a mounting baffle, and that enables all of the front exposed diaphragm surface to emit sound. By using a surround support entirely located within the rear perimeter edge of the diaphragm, and a conventional dynamic loudspeaker motor/driver and voice coil system sized to fit behind and entirely inside the perimeter edge of the acoustic diaphragm, the invention permits the entire diaphragm to visually fill an opening in a mounting baffle and emit sound.

### DESCRIPTION OF THE DRAWINGS

FIG. 1 shows a side sectional view of a loudspeaker in accordance with an embodiment of the present invention.

FIG. 2 shows an exploded view of the loudspeaker of FIG. 1.

### DETAILED DESCRIPTION OF EXEMPLARY EMBODIMENTS

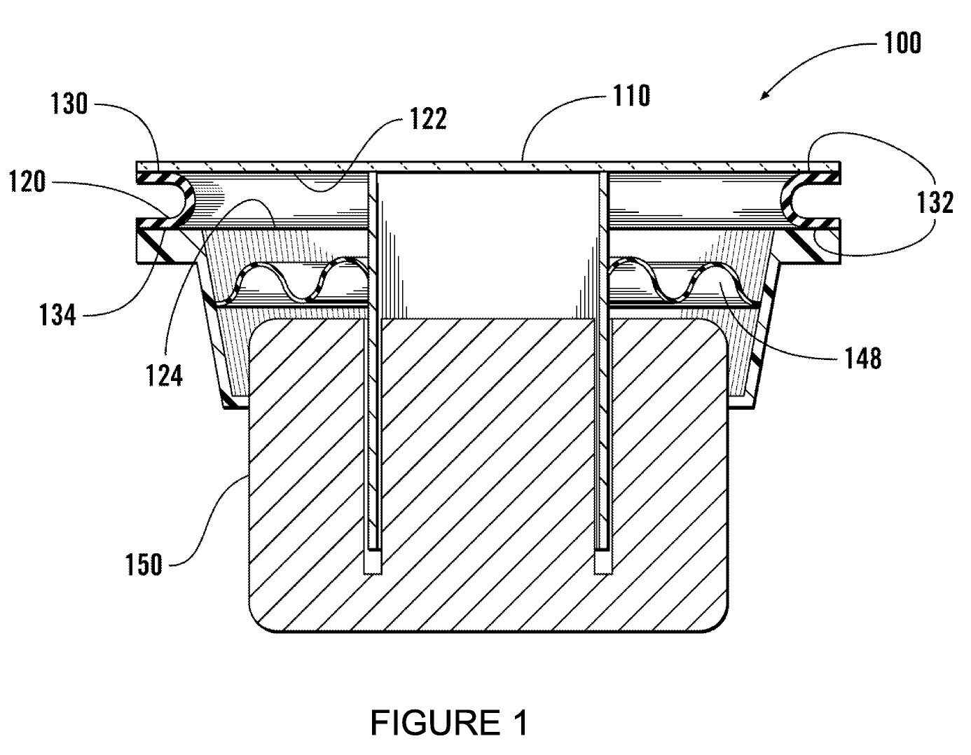

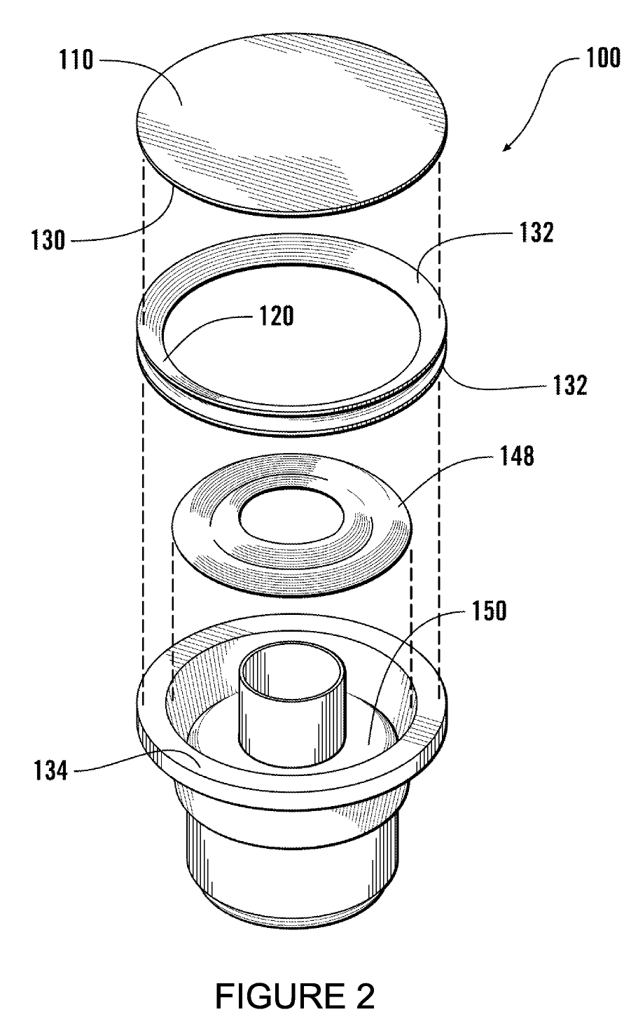

In one exemplary embodiment, as shown in FIGS. 1 and 2, an acoustic loudspeaker 100 comprises an acoustic diaphragm 110 supported on one side by surround support 120. The surround support 120 may be flexible, and may be made of rubber, plastic, paper, or similar material, or some combination thereof. The surround support 120 may be ring-shaped with an open center, and may comprise a solid band, or, as shown in FIGS. 1 and 2, may comprise a U-shape or V-shape when view in cross-section, with two mating surfaces 132, 134. The diaphragm mating surface 132 is affixed to the diaphragm 110 forming an upper joint 122, while the driver mating surface 134 is affixed to the driver 150 forming a lower joint 124. A flexible baffle 148 may located under the surround support, supported by the driver 150.

As shown, the outer circumference of the surround support should not extend beyond the edge of the diaphragm, and the surround support may be equal in diameter or, in fact, have a slightly smaller diameter than the diaphragm. In other embodiments, the diameter of the surround support may be slightly larger than the diaphragm, but in general, the surround support should not be so large as to be visible from the front of the loudspeaker.

The means of affixation can be any means known in the art, including, but not limited to, gluing or cementing. Further, while the figures show the diaphragm and surround support as circular, they can be of any suitable shape for loudspeakers, including oval or the like.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A loudspeaker assembly, comprising:
a driver;
a diaphragm with a face and a back; and
a flexible support with a diaphragm mating surface and a driver mating surface, said diaphragm mating surface affixed to the back of the diaphragm and said driver mating surface affixed to a surface on the driver.

2. The loudspeaker assembly of claim 1, wherein the support does not visibly extend beyond the outer edge of the diaphragm.

3. The loudspeaker assembly of claim 1, wherein the support has an open center.

4. The loudspeaker assembly of claim 1, wherein the support is made of rubber.

5. The loudspeaker assembly of claim 1, wherein the support is made of paper.

6. The loudspeaker assembly of claim 1, wherein the support is made of plastic.

7. The loudspeaker assembly of claim 1, wherein the support is a narrow ring affixed to the outer perimeter of the back of the diaphragm.

8. The loudspeaker assembly of claim 1, wherein only the diaphragm is visible when viewed from the face side.

9. The loudspeaker assembly of claim 1, wherein all of the exposed diaphragm emits sound.
